(19) United States
(12) Patent Application Publication
(10) Pub. No.: US 2026/0234757 A1
(43) Pub. Date: Aug. 13, 2026

(54) NITINB SHAPE MEMORY ALLOY AND PREPARATION METHOD THEREFOR

(71) Applicant: Central South University, Changsha (CN)

(72) Inventors: Yimin LI, Changsha (CN); Dongyang LI, Changsha (CN)

(73) Assignee: Central South University, Changsha (CN)

(21) Appl. No.: 19/638,150

(22) Filed: Apr. 3, 2026

Related U.S. Application Data
(63) Continuation of application No. PCT/CN2025/126981, filed on Oct. 11, 2025.

(30) Foreign Application Priority Data
Oct. 12, 2024 (CN) 2024114226079

(51) Int. Cl. C22C 19/03; C22C 1/04

(52) U.S. Cl. CPC C22C 19/03; C22C 1/0433

(57) ABSTRACT

Disclosed are a NiTiNb shape memory alloy and a preparation method therefor, the preparation method specifically including the following steps: (1) uniformly mixing a Ni source, a Ti source, and a Nb source to obtain a mixed powder material; (2) cold-press molding the mixed powder material to obtain an alloy green compact; and (3) sintering the green compact to obtain the NiTiNb shape memory alloy. The preparation method of this disclosure, by introducing the Nb source powder for sintering and regulating the sintering temperature parameters, can prepare a NiTiNb alloy with uniform composition and high density, and enable the NiTiNb alloy to have an increased strength of above 1,600 MPa, an increased density of up to 92%, a compressive strength of higher than 2,000 MPa, a fracture strain of higher than 30%, and an 8% tensile recovery rate of higher than 50%, significantly improving the mechanical properties of the alloy.

### CROSS-REFERENCE TO RELATED APPLICATIONS

The application claims priority to Chinese patent application No. 2024114226079, filed on Oct. 12, 2024, the entire contents of which are incorporated herein by reference.

### TECHNICAL FIELD

This disclosure relates to the technical field of shape memory materials and, in particular, to a NiTiNb shape memory alloy and a preparation method therefor.

### BACKGROUND

NiTi and NiTi-based shape memory alloys (SMAs) have become the most important SMAs due to their advantages such as good fatigue resistance, excellent shape memory effect, superelasticity, and good biocompatibility. Compared to binary NiTi alloys, the ternary NiTiNb, after the addition of Nb, exhibits larger phase transition hysteresis, as well as higher strength and plasticity. In addition, due to complex oxides on its surface, the alloy's corrosion resistance and biocompatibility are increased. Therefore, NiTiNb has very broad prospects in the field of engineering applications and biomedical applications.

However, at present, there are still many difficulties and problems in the preparation method of NiTiNb. The preparation of NiTiNb alloy by the smelting process has many problems, such as non-uniform composition and coarse grain size, which necessitate further post-treatment to ensure that the quality and performance of the finished product meet the requirements. Due to the significant differences in the melting points of Ni (1,726 K), Ti (1,941 K), and Nb (2,741 K), as well as chemical reactions at high temperatures, composition segregation is prone to occur during the smelting process, resulting in unfavorable mechanical properties. Therefore, heat treatment must be performed to optimize the product's microstructure and properties. Moreover, smelting can only produce finished products with a single geometry. To meet practical applications, forming processes (such as forging, hot drawing, and hot rolling) are required.

Powder metallurgy is one of the main methods for preparing NiTiNb. Powder metallurgy techniques, including die pressing & sintering, additive manufacturing, and injection molding, are an important class of preparation methods for NiTiNb alloys. They can improve material utilization, reduce processing amount, or construct gradient structures and porous structures that are difficult to achieve by ingot metallurgy. The vacuum reaction sintering method, which uses elemental powders as raw materials, has the advantages of flexible composition design, low cost, and simple process. However, due to sintering challenges, the alloys obtained by this method have uncontrollable pore structures and undesirable phases, as well as poor strength (tensile strength 131~282 MPa), which is significantly lower than the strength of alloys prepared by pre-alloyed powder sintering and casting metallurgy (600~930 MPa).

The preparation of NiTiNb is mainly constrained by two major challenges. The first is oxygen impurity contamination. Elemental powders using hydrogenated-dehydrogenated Ti powder as a raw material have a higher initial oxygen content, and new oxygen impurities are easily further introduced during the sintering process. An increase in oxygen content will lead to the formation of more brittle second phases, such as Ti₂Ni/(Ti,Nb)₂Ni. Although the second phases may increase the hardness of the alloy in some cases, they reduce the plasticity and toughness of the alloy. Therefore, improving the purity of raw materials and preventing impurity contamination during the preparation process have always been important measures for preparing high-performance NiTi-based alloys. Furthermore, the difference in diffusion rates between elemental powders and the complex and intense eutectic liquid phase reaction pose difficulties for the preparation of NiTi-based alloys. Due to the large difference in interdiffusion rates between elements, Kirkendall pores are formed, and the formation of such pores adversely affects the performance of the alloy. Simply increasing the sintering temperature is not only difficult to eliminate Kirkendall pores but also faces the problem of liquid phase loss. During the elemental reaction sintering process of binary NiTi alloys, due to the similar formation energies of Ti₂Ni, Ni₃Ti, and NiTi intermediate phases, these intermediate phases all appear around 720° C. Therefore, as the sintering temperature increases, liquid phases are generated by two eutectic reactions at 942° C. and 1,118° C., namely β-Ti(Ni)+Ti₂Ni→L and TiNi+TiNi₃→L, respectively. The distribution and volume fraction of these non-uniform eutectic liquid phases are very sensitive to the purity, size, and process conditions of the raw material powder. If not controlled properly, when the volume fraction of the liquid phases is too high, evaporation and loss will occur, causing large-scale pores and non-uniform composition, consequently affecting the dimensional accuracy and performance of the alloy. Moreover, after adding Nb, the eutectic reaction (1,150° C.) between the NiTi phase and the Nb phase introduces an additional liquid phase. Therefore, compared with binary NiTi alloys, the mixed liquid phase of ternary NiTiNb alloys during the reaction sintering process is additionally affected by Nb, making its properties more complex and more difficult to control. Impurity contamination and the generation and loss of mixed eutectic liquid phases are the main challenges faced in the preparation process of high-performance NiTiNb alloys. Therefore, developing a new preparation process to improve the current extremely poor performance of all NiTiNb alloys is of great significance to this technical field.

### SUMMARY

This disclosure is intended to solve the technical problems of impurity contamination and the generation and loss of mixed eutectic liquid phases in the preparation of NiTiNb alloys. To overcome the shortcomings and deficiencies mentioned in the above background, this disclosure provides a NiTiNb shape memory alloy and a preparation method therefor.

To solve the above technical problems, this disclosure proposes the following technical solution:

A preparation method for a NiTiNb shape memory alloy, specifically including the following steps:
(1) uniformly mixing a Ni source, a Ti source, and a Nb source to obtain a mixed powder material;
(2) cold-press molding the mixed powder material to obtain an alloy green compact; and
(3) sintering the green compact as follows: under a vacuum degree of 10⁻³~10⁻⁵ Pa, first heating to 580-620° C. at a rate of 5-10° C./min and holding for 0.5-2 h, then heating to 680-720° C. at a rate of 1-2° C./min and holding for 2-4 h, and then heating to 1,050-1,150° C. at a rate of 1-2° C./min and holding for 1-6 h, thereby obtaining a sintered sample, i.e., the NiTiNb shape memory alloy.

Compared with the smelting process that requires subsequent heat treatment, powder pressing reaction sintering can not only directly regulate the microstructure and properties of the material by adjusting the sintering process parameters, but also obtain high-performance components with uniform composition, which can meet various engineering requirements. In the sintering preparation of binary elemental powder NiTi alloys or porous NiTi alloys, local coarse Ni₄Ti₃ precipitates are prone to form due to carbon and oxygen impurities, which is detrimental to the mechanical properties of the alloy, thus requiring subsequent heat treatment to eliminate the coarse precipitates.

Through the sintering mechanism of the NiTiNb shape memory alloy, we can find that although the appearance of complex eutectic liquid phases increases the difficulty of alloy preparation, if the liquid phases are reasonably controlled and utilized, element diffusion can be promoted, the alloy densification process can be accelerated, and the coarse precipitates formed during sintering can be eliminated, thereby significantly improving the performance of the alloy.

Based on the above analysis of the sintering mechanism of the NiTiNb alloy, the sintering solution of the present application mainly focuses on optimizing the suitability of the Nb addition amount by adjusting the volume fraction of the NiTi—Nb eutectic liquid phase to promote homogenization and densification. In this context, the regulation of sintering process parameters is crucial. The present application employs a reasonable oxygen control strategy in the preparation solution. By optimizing the sintering process, it achieves good control over the eutectic liquid phase in the NiTiNb alloy. The eutectic liquid phase is utilized to promote composition homogenization and matrix densification, thereby significantly enhancing the mechanical properties and shape memory effect of the elemental powder NiTiNb alloy.

Since the formation of Ti₂Ni and Ni₃Ti during the sintering process is unavoidable, the present application sets a holding platform at 600° C. during the initial heating stage. This can substantially eliminate β-Ti, which will reduce the eutectic melting (β-Ti+Ti₂Ni→L) during the further heating process and minimize large-scale pore defects caused by self-propagating deflagration reactions. Subsequently, holding platforms are set in a range of 700° C. to 1,150° C. mainly for allowing eutectic reactions involving Ni₃Ti and Nb (Ni₃Ti+NiTi→L, Nb+NiTi→L) to occur, but without generating an excessive liquid phase due to the effect of temperature increase, thereby preventing loss caused by an excessively high volume fraction of a local liquid phase.

Since the formation of Ti₂Ni and Ni₃Ti during the sintering process cannot be regulated, the eutectic liquid phase generated by them is difficult to control and is prone to loss, leading to pore formation. In contrast, the liquid phase generated by the NiTi—Nb eutectic reaction involving Nb can be regulated by adjusting the parameters of Nb, thereby achieving the goal of controllable liquid phase sintering and attaining the effects of composition homogenization and matrix densification.

During the solid-state diffusion process, differences in the diffusion rates of elements between powders lead to Kirkendall pores that are difficult to avoid. By regulating the NiTi—Nb eutectic liquid phase, the liquid phase can fill some of the pores under the action of capillary force. More importantly, the liquid phase can significantly promote the diffusion of elements, weaken the biased diffusion effect in solid-state diffusion, and promote densification.

Preferably, an atomic ratio of Ni to Ti in the Ni source and the Ti source is (50.0-51.0):(49.0-50.0), more preferably 50.5:49.5.

Preferably, an addition amount of the Nb source is such that Nb accounts for 1 at. % to 15 at. % of the mixed powder material, more preferably any one of 3 at. %, 9 at. %, or 12 at. %.

At room temperature, the maximum solid solubility of Nb in the B2 NiTi lattice is 5 at. %. When the Nb content exceeds 5 at. %, the excess Nb exists as β-Nb with a BCC structure. As the Nb content increases, the change sequence of the alloy's microstructure is “B2→B2+eutectic→eutectic→β-Nb+eutectic”. Different Nb contents cause significant changes in the microstructure, affecting the mechanical properties and phase transition behavior of the NiTiNb alloy. For example, the soft and tough β-Nb phase can participate in the deformation of the alloy, improving its mechanical properties. Nb dissolved in the NiTi lattice causes severe lattice distortion, which is beneficial for increasing the thermal hysteresis width of phase transition. The present application selects an appropriate addition amount of the Nb source and regulates the NiTi—Nb eutectic liquid phase by adjusting the parameters of Nb, thereby achieving the goal of controllable liquid phase sintering and attaining the effects of composition homogenization and matrix densification.

Preferably, the Ni source is carbonyl Ni powder, the Ti source is hydrogenated-dehydrogenated Ti powder, and the Nb source is Nb powder.

Preferably, the hydrogenated-dehydrogenated Ti powder has a particle size of −325 mesh to −200 mesh, more preferably −325 mesh.

Preferably, the carbonyl Ni powder has a particle size of −2,000 mesh to −800 mesh, more preferably −1,250 mesh.

Preferably, the Nb powder has a particle size of −325 mesh to −200 mesh, more preferably −325 mesh.

Preferably, the cold press molding is performed under a pressure of 350-550 MPa.

Under the same technical concept, this disclosure further provides a NiTiNb shape memory alloy obtained by the preparation method described above.

Preferably, the NiTiNb alloy has a fracture stress strength of not less than 1,600 MPa, a density of not less than 92%, a compressive strength of higher than 2,000 MPa, a fracture strain of higher than 30%, an 8% tensile recovery rate of higher than 50%, an oxygen content of 0.18~0.22 wt. %, and a carbon content of 0.07~0.08 wt. %.

Compared with the prior art, this disclosure has the following beneficial effects:

(1) the preparation method of this disclosure, by introducing the Nb source powder for sintering and regulating the sintering temperature parameters, can prepare a NiTiNb alloy with uniform composition and high density, and enable the NiTiNb alloy to have an increased strength of above 1,600 MPa, an increased density of up to 92%, a compressive strength of higher than 2,000 MPa, a fracture strain of higher than 30%, and an 8% tensile recovery rate of higher than 50%, significantly improving the mechanical properties of the alloy.

(2) This disclosure performs sintering of the NiTiNb alloy in a vacuum system of 10⁻⁴ Pa throughout the process, reducing the oxygen content of the alloy to 0.18~0.21 wt. %. By strictly controlling the oxygen flow during the reaction, the generation of impurity phases can be greatly reduced, ensuring the purity of the product.

(3) The preparation method of this disclosure is simple and easy to implement, only requiring variable temperature sintering without subsequent steps such as aging heat treatment, and the sintering temperature is within a reasonable range, thus having high industrial value.

### BRIEF DESCRIPTION OF THE DRAWINGS

To describe the technical solutions of the embodiments of this disclosure or in the prior art more clearly, the accompanying drawings required for describing the embodiments or the prior art will be briefly described below. Apparently, the accompanying drawings in the following description show some embodiments of this disclosure, and a person of ordinary skill in the art may further derive other drawings from these accompanying drawings without making creative efforts.

FIG. 1 shows the morphology of elemental Ni, Ti, and Nb powders at the same magnification;

FIG. 2 is a schematic diagram of the microstructure of NiTiNb alloys with different Nb addition amounts sintered at 700-1,150° C. for 2 h in Examples 1-9;

FIG. 3 is a schematic diagram of the microstructure of NiTiNb alloys with different Nb addition amounts sintered at 1,200° C. for 2 h in Comparative Examples 1-3;

FIG. 4 shows the XRD results at room temperature (25° C.) of NiTiNb alloys with different Nb addition amounts sintered at different temperatures in Examples 1-9;

FIG. 5 shows the grain characteristics of alloys with different Nb addition amounts sintered at 1,150° C. in Examples 1-9, determined by EBSD testing;

FIG. 6 shows the TEM images of NiTiNb alloys in Examples 1-9;

FIG. 7 shows nanoscale 3-Nb precipitates observed within the grains and at the grain boundaries of NiTiNb alloys in Examples 1-9;

FIG. 8 shows the engineering stress-strain curves at room temperature of NiTiNb alloys with different Nb addition amounts sintered at different temperatures in Examples 1-9;

FIG. 9 shows the stress-strain curves of NiTiNb alloys in Examples 1-9 during an 8% pre-strain loading-unloading process at room temperature; and

FIG. 10 shows the morphology of alloys compressed to failure in Examples 1-9.

### DETAILED DESCRIPTION OF THE EMBODIMENTS

To help understand this disclosure, this disclosure will be described more comprehensively and in detail below in conjunction with the accompanying drawings and exemplary embodiments, but the scope of protection of this disclosure is not limited to the following embodiments.

Unless otherwise defined, all technical terms used herein have the same meanings as those commonly understood by those skilled in the art. The technical terms used herein are merely for the purpose of describing the embodiments rather than for limiting the scope of protection of this disclosure.

Unless otherwise specified, various raw materials, reagents, instruments, and devices used in this disclosure are commercially available or can be prepared by existing methods.

### Example 1

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 3 at. %) to obtain a mixed powder material, where the theoretical composition of the mixed powder material was Ni₄₉Ti₄₈Nb₃;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,050° C. at a rate of 1° C./min and holding for 2 h;
where an obtained EP NiTi alloy had an oxygen content of 0.18 wt. %, a density of about 79.7%, a compressive strength of 1,797 MPa, an ultimate fracture strain of 28.7%, and a shape recovery rate of 69.7% after 8% strain compression.

### Example 2

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 9 at. %) to obtain a mixed powder material, where the theoretical composition of the mixed powder material was Ni_{46.3}Ti_{45.4}Nb_{8.3};
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,050° C. at a rate of 1° C./min and holding for 2 h;
where an obtained EP NiTi alloy had an oxygen content of 0.20 wt. %, a density of about 79.4%, a compressive strength of 1,662 MPa, an ultimate fracture strain of 30.4%, and a shape recovery rate of 62.8% after 8% strain compression.

### Example 3

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 12 at. %) to obtain a mixed powder material, where the theoretical composition of the mixed powder material was Ni₄₅Ti₄₄Nb₁₁;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,050° C. at a rate of 1° C./min and holding for 2 h;
where an obtained EP NiTi alloy had an oxygen content of 0.21 wt. %, a density of about 79.4%, a compressive strength of 1,785 MPa, an ultimate fracture strain of 32.8%, and a shape recovery rate of 63.2% after 8% strain compression.

### Example 4

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 3 at. %) to obtain a mixed powder material, where the theoretical composition of the mixed powder material was Ni₄₉Ti₄₈Nb₃;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,120° C. at a rate of 1° C./min and holding for 2 h;
where an obtained EP NiTi alloy had an oxygen content of 0.20 wt. %, a density of about 82.5%, a compressive strength of 1,991 MPa, an ultimate fracture strain of 28.3%, and a shape recovery rate of 52.3% after 8% strain compression.

### Example 5

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 9 at. %) to obtain a mixed powder material, where the theoretical composition of the mixed powder material was Ni_{46.3}Ti_{45.4}Nb_{8.3};
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,120° C. at a rate of 1° C./min and holding for 2 h;
where an obtained EP NiTi alloy had an oxygen content of 0.21 wt. %, a density of about 83.4%, a compressive strength of 1,986 MPa, an ultimate fracture strain of 31.2%, and a shape recovery rate of 56.7% after 8% strain compression.

### Example 6

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 12 at. %) to obtain a mixed powder material, where the theoretical composition of the mixed powder material was Ni₄₅Ti₄₄Nb₁₁;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,120° C. at a rate of 1° C./min and holding for 2 h;
where an obtained EP NiTi alloy had an oxygen content of 0.21 wt. %, a density of about 83.8%, a compressive strength of 1,739 MPa, an ultimate fracture strain of 30.2%, and a shape recovery rate of 54.1% after 8% strain compression.

### Example 7

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 3 at. %) to obtain a mixed powder material, where the theoretical composition of the mixed powder material was Ni₄₉Ti₄₈Nb₃;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,150° C. at a rate of 1° C./min and holding for 2 h;
where an obtained EP NiTi alloy had an oxygen content of 0.22 wt. %, a density of about 84.5%, a compressive strength of 2,185 MPa, an ultimate fracture strain of 30.6%, and a shape recovery rate of 55.2% after 8% strain compression.

### Example 8

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 9 at. %) to obtain a mixed powder material, where the theoretical composition of the mixed powder material was Ni_{46.3}Ti_{45.4}Nb_{8.3};
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,150° C. at a rate of 1° C./min and holding for 2 h;
where an obtained EP NiTi alloy had an oxygen content of 0.20 wt. %, a density of about 86.6%, a compressive strength of 2,009 MPa, an ultimate fracture strain of 29.1%, and a shape recovery rate of 54.1% after 8% strain compression.

### Example 9

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 12 at. %) to obtain a mixed powder material, where the theoretical composition of the mixed powder material was Ni₄₅Ti₄₄Nb₁₁;
(2) cold-press molding the mixed powder material under 400 MPa;
(3) sintering a desalted green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,150° C. at a rate of 1° C./min and holding for 2 h;
where an obtained EP NiTi alloy had an oxygen content of 0.21 wt. %, a density of about 92.0%, a compressive strength of 2,050 MPa, an ultimate fracture strain of 30.4%, and a shape recovery rate of 53.6% after 8% strain compression.

### Comparative Example 1

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 3 at. %) to obtain a mixed powder material, where the theoretical composition of the mixed powder material was Ni₄₉Ti₄₈Nb₃;
(2) cold-press molding the mixed powder material under 400 MPa;
(3) sintering a green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,200° C. at a rate of 1° C./min and holding for 2 h;
where an obtained EP NiTi alloy had an oxygen content of 0.22 wt. % and a density of about 68.4%, and due to an excessive volume fraction of the generated liquid phase, the liquid phase was subjected to evaporation and loss, resulting in composition segregation and large-scale pore defects.

### Comparative Example 2

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 9 at. %) to obtain a mixed powder material, where the theoretical composition of the mixed powder material was Ni_{46.3}Ti₄₅₄Nb_{8.3};
(2) cold-press molding the mixed powder material under 400 MPa;
(3) sintering a green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,200° C. at a rate of 1° C./min and holding for 2 h;
where an obtained EP NiTi alloy had an oxygen content of 0.22 wt. % and a density of about 65.9%, and due to an excessive volume fraction of the generated liquid phase, the liquid phase was subjected to evaporation and loss, resulting in composition segregation and large-scale pore defects.

### Comparative Example 3

A preparation method for a NiTiNb shape memory alloy, including the following steps:
(1) uniformly mixing hydrogenated-dehydrogenated Ti powder (−325 mesh, 49.5 at. %), carbonyl Ni powder (−1,250 mesh, 50.5 at. %), and Nb powder (−325 mesh, 12 at. %) to obtain a mixed powder material, where the theoretical composition of the mixed powder material was Ni₄₅Ti₄₄Nb₁₁;
(2) cold-press molding the mixed powder material under 400 MPa;
(3) sintering a green compact as follows: under a vacuum degree of 10⁻⁴ Pa, first heating to 600° C. at a rate of 5° C./min and holding for 0.5 h, then heating to 700° C. at a rate of 1° C./min and holding for 2 h, and then heating to 1,200° C. at a rate of 1° C./min and holding for 2 h;
where an obtained EP NiTi alloy had an oxygen content of 0.22 wt. % and a density of about 79.9%, and due to an excessive volume fraction of the generated liquid phase, the liquid phase was subjected to evaporation and loss, resulting in composition segregation and large-scale pore defects.

To further verify the sintering parameters of this disclosure and the effect of the Nb addition amount on product performance, this disclosure provides the following experimental data for Examples 1-9 and Comparative Examples 1-3:

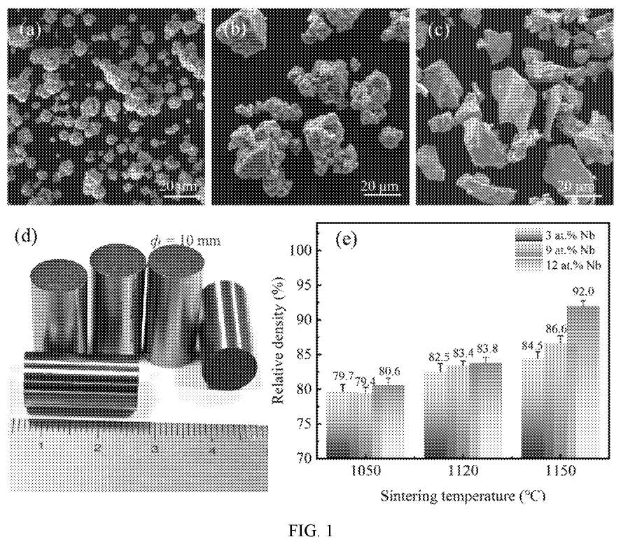

FIGS. 1(a), 1(b) and 1(c) show the morphology of elemental Ni, Ti, and Nb powders, respectively, at the same magnification. FIG. 1(d) shows a physical image of NiTiNb used for mechanical property testing. The relative density of NiTiNb with different Nb addition amounts sintered at different temperatures is shown in FIG. 1(e). The relative density of the alloy increased with the sintering temperature (the final sintering temperature increased from 700° C. to 1,150° C.). The relative density of the alloy with 3 at. % Nb added increased from 79.7% to 84.5%. The relative density of the alloy with 9 at. % Nb added increased from 79.4% to 86.6%. The relative density of the alloy with 12 at. % Nb added increased from 80.6% to 92.0%. The addition of Nb was also beneficial for improving the relative density of the alloy. When the sintering temperature was 1,150° C., the relative density of the alloy increased significantly with the Nb addition amount. The carbon and oxygen contents of the as-sintered alloy generally remained at a relatively low level. The increase in sintering temperature had little effect on the carbon and oxygen contents; the oxygen content of the alloy was 0.18-0.22 wt. %, and the carbon content was 0.07~0.08 wt. %.

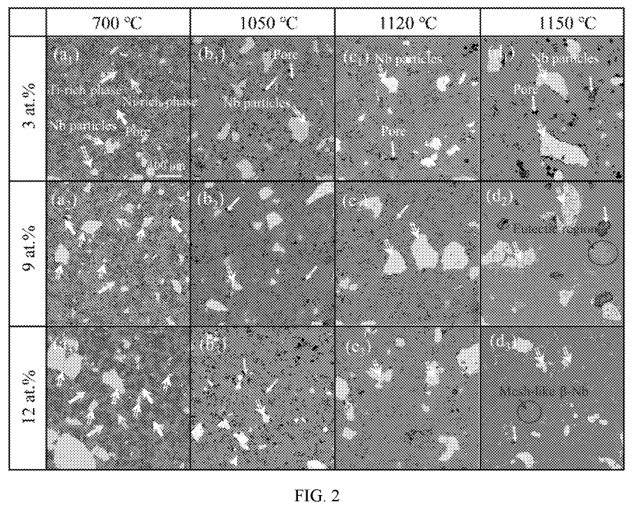

FIG. 2(a₁-a₃) shows the microstructure of NiTiNb alloys with 3 at. %, 9 at. %, and 12 at. % Nb addition amounts sintered at 700° C. for 2 h. The alloy surface was mainly composed of white Nb particles, dark gray Ti-rich phases, light gray Ni-rich phases, and residual pores. FIG. 2(b₁-b₃) shows the microstructure of NiTiNb alloys with 3 at. %, 9 at. %, and 12 at. % Nb addition amounts sintered at 1,050° C. for 2 h. A large number of pores existed on the surface of the samples sintered at 1,050° C., and the increase in Nb addition amount had no significant effect on the microstructure of the alloys. Compared with the samples sintered at 700° C., after sintering at 1,050° C., the composition of the alloys was more homogeneous. The matrix was mainly composed of a gray NiTi phase and also included a dark gray (Ti, Nb)₂Ni phase and isolated Nb particles, with no Ni₃Ti phase observed. The appearance of the (Ti, Nb)₂Ni phase was due to the fact that Nb dissolved in the alloys tended to substitute for Ti sites. The edges of Nb particles and the NiTi phase were observed at a higher magnification. As the sintering temperature increased to 1,120° C., the microstructure of NiTiNb alloys did not change significantly, and the volume fraction of pores decreased slightly, as shown in FIG. 2(c₁-c₃). The microstructure of alloys with different Nb contents sintered at 1,150° C. for 2 h is shown in FIG. 2(d₁-d₃). The volume fraction of pores in the alloy with 3 at. % Nb added was further reduced, and the phase composition did not change significantly. As the Nb addition amount increased to 9 at. %, an obvious eutectic region appeared in the alloy, indicating that a vigorous eutectic reaction between NiTi and Nb occurred during the sintering process. R—Nb produced by the eutectic reaction mainly exhibited network-like, sphere-like, and rod-like morphologies, with no obvious regularity in the size and morphology distribution. The number of micropores in the matrix decreased significantly, and the volume fraction of pores was significantly reduced. In the alloy with 12 at. % Nb added, p-Nb mainly exhibited a network-like morphology. The volume fraction of pores in the matrix was further reduced. When the sintering temperature was 1,150° C., a significant eutectic reaction occurred between Nb and NiTi, accompanied by the precipitation of a large amount of 3-Nb precipitates. As the Nb addition amount increased, the number of pores decreased.

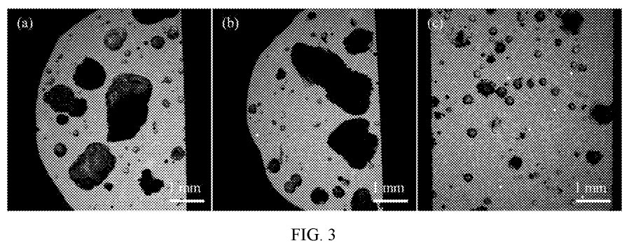

FIG. 3(a-c) shows the microstructure of NiTiNb alloys with 3 at. %, 9 at. %, and 12 at. % Nb addition amounts sintered at 1,200° C. for 2 h in Comparative Examples 1-3, respectively. The samples were mainly composed of gray NiTi, and also included dark gray (Ti, Nb)₂Ni and network-like Nb. In addition, millimeter-scale macroscopic pore defects were caused by the loss and evaporation of liquid phases. When a large amount of NiTi—Nb eutectic liquid phase solidified, it preferentially nucleated at the grain interfaces, causing the Nb phase to mainly aggregate at the grain interfaces of the NiTi matrix, distributed in a network pattern.

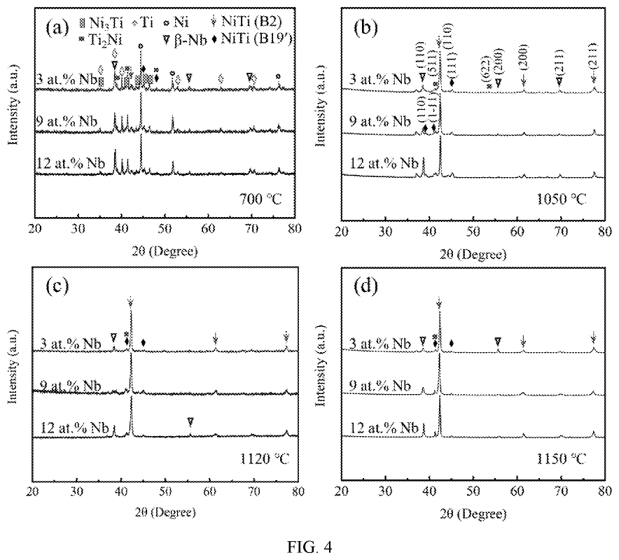

FIG. 4 shows the XRD results at room temperature (25° C.) of NiTiNb alloys with different Nb addition amounts sintered at different temperatures. The phases of the alloys sintered at a sintering temperature of 700° C. were all composed of Ni₃Ti, Ti₂Ni, R—Nb, and a small amount of B2 NiTi, B19′ NiTi, and unreacted elemental Ni and Ti phases. The increase in Nb content had no significant effect on the phase composition of the alloys. As the sintering temperature rose to 1,050° C., as shown in FIG. 4b, the alloys were mainly composed of B2 NiTi and β-Nb, containing a small amount of B19 NiTi and Ti₂Ni/(Ti, Nb)₂Nb, which was consistent with the SEM results. The disappearance of the Ni₃Ti phase indicated the occurrence of the reaction NiTi+Ni₃Ti→L. Due to the presence of a high-melting-point oxide film on the surface of Ti₂Ni, it was difficult to eliminate, so it existed stably in the matrix. When the Nb addition amount increased to more than 9 at. %, a weak B19′ martensite diffraction peak in the (110) direction appeared in the alloy sintered at 1,050° C. When the sintering temperature was increased, this diffraction peak disappeared. As shown in FIGS. 4b and 4c, there was no significant difference in the phase composition of alloys with different Nb contents sintered at 1,120° C.~1,150° C., which were mainly composed of B2 NiTi, β-Nb, B19′ NiTi, and Ti₂Ni phases. The change in Nb content had no significant effect on the phase composition of the alloys.

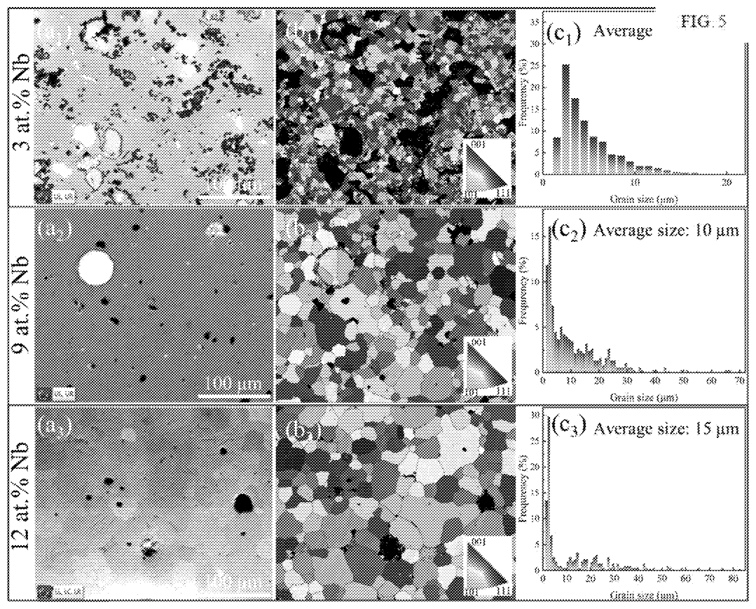

FIG. 5 shows the grain characteristics of alloys with different Nb addition amounts sintered at 1,150° C., determined by EBSD testing. In the EBSD phase reconstruction map of the NiTiNb alloy matrix, the matrix was mainly composed of equiaxed grains. The size distribution of the austenite grains is shown in FIG. 4c. The average grain size of the alloy increased from 5 μm to 15 μm as the Nb content increased. This indicates that the austenite grains of the NiTiNb alloy sintered at 1,150° C. coarsen with the increase in Nb addition amount. The change in grain size will affect the mechanical properties and phase transformation behavior of the alloy.

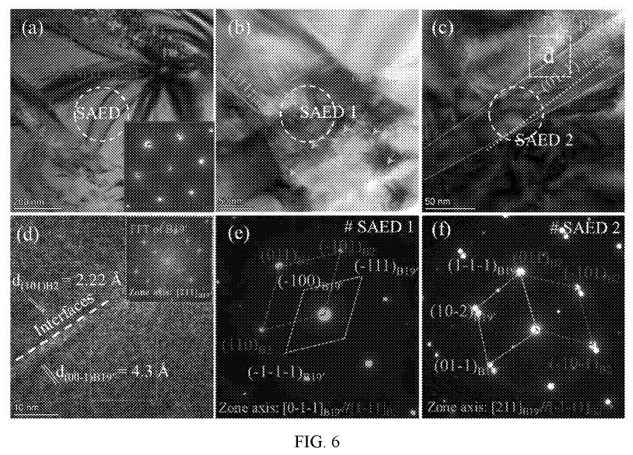

FIG. 6 shows TEM images, indicating that the NiTi matrix was mainly composed of austenite (B2), containing some martensite (B19′), which was consistent with the XRD and EBSD results. The small amount of martensite mainly included [111] I-type and [011] II-type, with shapes divided into acicular (FIG. 6b) and lath-like (FIG. 6c) shapes. The SAED results showed that the crystallographic orientation relationship between [111]_{I-type} B19′ and B2 was (0-1-1)_{B19′}//(110)_{B2}, [0-1-1]B_{19′}//[1-11]_{B2}, and the crystallographic orientation relationship between [0111]_{II-type} B19′ and B2 was (1-1-1)_{B19′}//(011)_{B2}, [211]_{B19′}//[−1−11]B2. The measured interplanar spacings of B2 and B19′ were d_{(110)B2}=2.18~2.22 Å and d_{(00-1)B19′}=4.30 Å, respectively. The mismatch between the two phases was calculated by the interfacial mismatch formula.

$$δ = \frac{2 ( {α}_{β} - {α}_{α} )}{{α}_{β} + {α}_{α}} \qquad ( 1 )$$

where δ represents the mismatch between the two phases, and α_{α} and α_{β} represent the interplanar spacings of the two phases, respectively. The mismatch between (101)_{B2} and (001)_{B19′} was 0.64, indicating that the interface between B2 and B19′ was an incoherent interface.

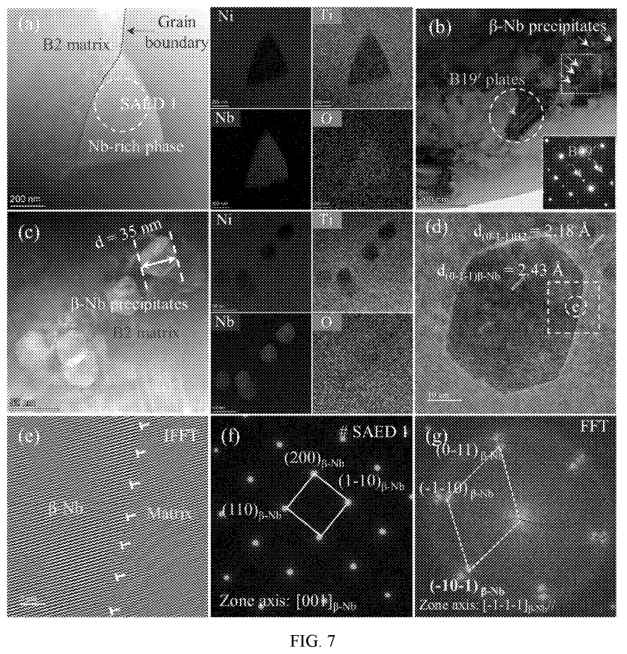

FIG. 7 shows nanoscale β-Nb precipitates observed within the grains and at the grain boundaries. The nanoscale precipitates within the grains had a size of approximately 35 nm at a high magnification. The EDS results all showed significant Nb enrichment, which, combined with the corresponding SAED results (FIG. 7), further confirmed that the white nanoscale precipitates were β-Nb. Fast Fourier Transform results (FIG. 7g) showed that the crystallographic orientation relationship between β-Nb and B2 was (0-11)_{β-Nb}//(0-11)_{B2}, [−1−1−1]_{β-Nb}//[1-11]_{B2}. The interfacial relationships between B2, B19′, and β-Nb were further analyzed by HRTEM. The measured interplanar spacing of β-Nb was d_{(0-11)β-Nb}=2.43 Å. The mismatch between (0-1-1)_{B2} and (0-11)_{β-Nb} was 0.11, which proved that the interface between B2 and the nanoscale β-Nb precipitates was a semi-coherent interface. Further IFFT analysis was performed on the interface between β-Nb and B2 (FIG. 7e), and dislocations were found at their interface. The interfacial mismatch dislocations between the nanoscale precipitates and the B2 matrix appeared periodically on average every 10/11 {110}_{B2} planes of the precipitates and the matrix, respectively, which was close to the calculated lattice mismatch of 0.11. This interfacial relationship accommodated almost all of the lattice mismatch between the two structures, which was consistent with the results of H. Shi, S, et al. This indicates that nanoscale β-Nb precipitates can achieve good bonding with the B2 matrix by forming interfacial dislocations, thereby providing a good precipitation strengthening effect and improving mechanical properties.

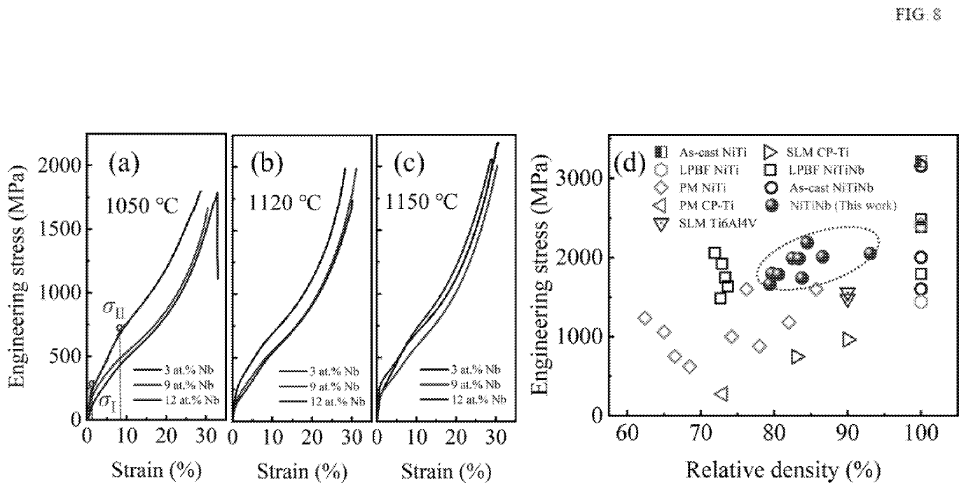

FIG. 8(a-c) shows the engineering stress-strain curves at room temperature of NiTiNb alloys with different Nb addition amounts sintered at different temperatures. The alloys did not exhibit multi-stage fracture phenomena due to the presence of residual pores during compression, but underwent complete fracture failure when the stress reached the maximum value. When the sintering temperature was 1,050° C., the ultimate compressive strength (UCS) of the alloys with 3 at. %, 9 at. %, and 12 at. % Nb added were 1,797 MPa, 1,662 MPa, and 1,785 MPa, respectively, and the corresponding maximum strain (MS) were 29%, 30%, and 33%, respectively. As the sintering temperature increased to 1,150° C., the UCS of the alloys increased significantly. With the increase in Nb addition amount, the UCS of the alloys reached 2,185 MPa, 2,009 MPa, and 2,050 MPa, respectively, and the corresponding MS were 31%, 29%, and 30%, respectively. It can be seen that the effect of the Nb addition amount on the UCS of the alloy was relatively small, while the effect of the sintering temperature on the UCS of the alloy was more significant. FIG. 7d shows the relationship between the strength and relative density of common titanium alloys prepared by different processes, specifically including CP—Ti, Ti6Al4V, NiTi, and NiTiNb alloys prepared by smelting & forging, vacuum sintering, laser powder bed fusion, and selective laser melting. It can be seen from the figure that as the relative density increased, the UCS of the alloy increased. Compared with the data reported in the literature, the NiTiNb alloy prepared by elemental powder reaction sintering in this study has a maximum ultimate compressive strength of 2,185 MPa and a fracture strain of 31%, which is comparable to or even exceeds that of some high-density NiTiNb alloys (UCS 2,000, MS 35%) prepared by smelting & casting and other titanium alloys.

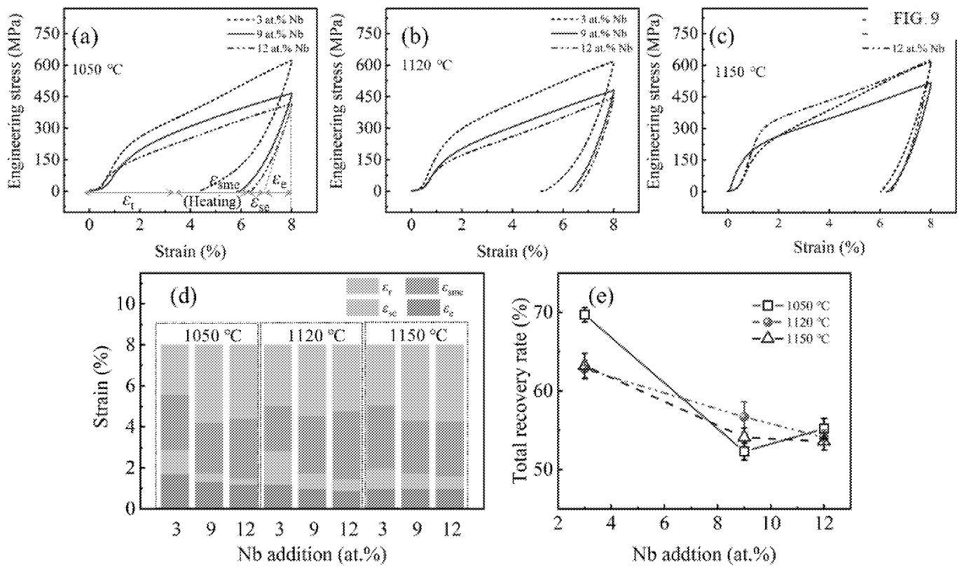

FIG. 9 shows the stress-strain curves of NiTiNb alloys during an 8% pre-strain loading-unloading process at room temperature. Since the alloys had a porous structure and were mainly composed of austenite, martensite, and p-Nb phases at room temperature, stress-induced martensitic transformation (SIM), martensite reorientation, and plastic deformation might occur in the alloys during compression. According to literature reports, the strain during the unloading process was divided into elastic recovery strain (εₑ), superelastic recovery strain (εₛₑ), heating recovery strain (εₛₘₑ), and residual strain (εᵣ), as shown in FIG. 9a. The εₑ, εₛₑ, εₛₘₑ, and εᵣ of the alloys are shown in FIG. 9d. Although the alloys were mainly austenitic at room temperature, during the stress loading-unloading-heating test process, the strain recovered by heating for all alloys was higher than the superelastic recovery strain. FIG. 9e summarizes the total shape recovery rate of the alloys. After 8% strain loading-unloading, the total shape recovery rate of the alloys decreased significantly with the increase in Nb addition amount.

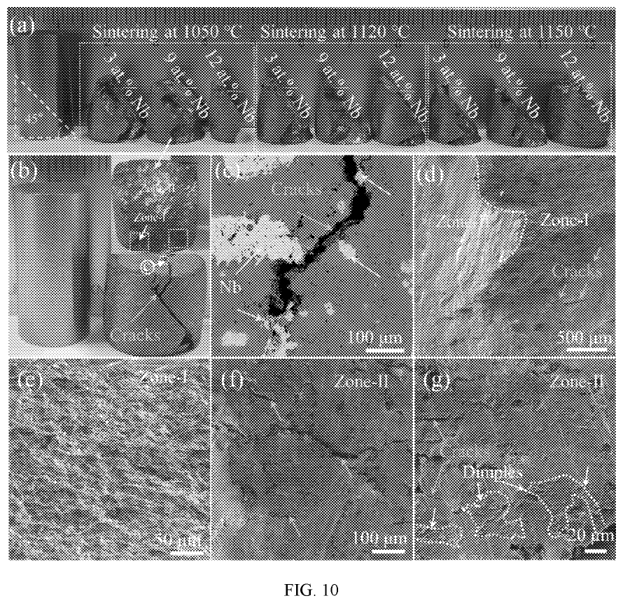

FIG. 10 shows the morphology of alloys compressed to failure. During compression, plastic metal materials mainly undergo upsetting deformation. During the increase in compressive stress, not only does the height decrease, but the transverse area also increases. After the samples failed by fracture, the height decreased to about 70% of the original height, and the cross-sectional area increased significantly. The fracture surfaces of all alloys exhibited a sheared fracture morphology at approximately 43°-47°. The fracture surface of the alloy with an Nb addition amount of 9 at. % sintered at 1,050° C. is shown in the inset in FIG. 10b. The fracture surface mainly included a necking zone (Zone-I) and a fracture propagation zone (Zone-II). On the end surface SEM of the failed sample (FIG. 10c), it was found that the fracture propagation direction was deflected at the Nb particles, indicating that Nb can achieve a toughening effect by hindering fracture propagation. FIG. 10d shows the interfacial morphology between the necking zone and the fracture propagation zone. The fracture morphology of the necking zone observed at a high magnification is shown in FIG. 10e. The necking zone was mainly composed of uneven dimples. The surface of the fracture propagation zone was relatively smooth, with very fine wavy slip lines. FIGS. 10f and 10g show the morphology of the necking zone at a higher magnification. Cracks and “ripple”-like dimples existed in the necking zone. Fracture surface morphology analysis indicated that the failure mechanism of the alloy was mainly ductile fracture.

What is claimed is:

1. A preparation method for a NiTiNb shape memory alloy, wherein the NiTiNb shape memory alloy has a relative density of 96%-99%, and the preparation method specifically comprises the following steps:
(1) uniformly mixing a Ni source, a Ti source, and a Nb source to obtain a mixed powder material, wherein the Nb source is Nb powder having a particle size of −900 mesh to −500 mesh; an addition amount of the Nb source is such that Nb accounts for 9 at. % to 15 at. % of the mixed powder material; and an atomic ratio of Ni to Ti in the Ni source and the Ti source is (50.0-51.0):(49.0-50.0);
(2) cold-press molding the mixed powder material to obtain an alloy green compact; and
(3) sintering the green compact as follows: under a vacuum degree of 10⁻⁵~10⁻³ Pa, first heating to 580-620° C. at a rate of 5-10° C./min and holding for 0.5-2 h, then heating to 680-720° C. at a rate of 1-2° C./min and holding for 2-4 h, and then heating to 1,130-1,150° C. at a rate of 1-2° C./min and holding for 1-6 h, thereby obtaining a sintered sample, i.e., the NiTiNb shape memory alloy.

2. The preparation method of claim 1, wherein the Ni source is carbonyl Ni powder, and the Ti source is hydrogenated-dehydrogenated Ti powder.

3. The preparation method of claim 2, wherein the hydrogenated-dehydrogenated Ti powder has a particle size of −325 mesh to −200 mesh.

4. The preparation method of claim 2, wherein the carbonyl Ni powder has a particle size of −2,000 mesh to −800 mesh.

5. The preparation method of claim 1, wherein the cold-press molding is performed under a pressure of 350-550 MPa.

6. A NiTiNb shape memory alloy, obtained by the preparation method of claim 1.

7. The NiTiNb shape memory alloy of claim 6, having a tensile fracture stress strength of 263-709 MPa, a relative density of 96%-99%, an elongation of 3.5-12.6%, a martensitic phase transition peak temperature of −17° C. to −59° C., an austenitic phase transition peak temperature of 1.3° C. to 37° C., an oxygen content of not higher than 0.22 wt. %, and a carbon content of not higher than 0.08 wt. %.
